(19) United States
(12) Patent Application Publication
(10) Pub. No.: US 2020/0246817 A1
(43) Pub. Date: Aug. 6, 2020

(54) Method and System for Dispensing a Liquid

(71) Applicant: Dispensing Technologies B.V., Helmond (NL)

(72) Inventors: Wilhelmus Johannes Joseph Maas, Someren (NL); Paulo Nervo, Hoogeloon (NL); Dennis Van Melick, Eindhoven (NL)

(21) Appl. No.: 16/753,122

(22) PCT Filed: Oct. 3, 2018
(86) PCT No.: PCT/EP2018/076924

§ 371 Date: Apr. 2, 2020

Related U.S. Application Data
(60) Provisional application No. 62/567,706, filed on Oct. 3, 2017.

(51) Int. Cl. B05B 11/00

(52) U.S. Cl. CPC B05B 11/0056; B05B 11/3001; B05B 11/0097

(57) ABSTRACT

The invention relates to a liquid dispensing system comprising a liquid dispensing device (2) and one or more containers (3) for storing the liquid to be dispensed, wherein the liquid dispensing device is releasably connected to one of the containers. The liquid dispensing system includes means for preventing refilling of the at least one container. The refill prevention means may include a restriction element (7) which may be fixed in a neck of the container and may almost completely close off a fill opening defined by the neck. The invention further relates to a method of dispensing a liquid, comprising the steps of filling at least one container with the liquid to be dispensed, providing a liquid dispensing device, connecting the liquid dispensing device to the at least one container, and actuating the liquid dispensing device, wherein after filling the container is provided with means for preventing refilling thereof.

The present invention relates to a liquid dispensing system comprising a liquid dispensing device and at least one container for storing the liquid to be dispensed, wherein the liquid dispensing device includes first connecting means and the at least one container contains second connecting means, said first and second connecting means being arranged to cooperate to releasably connect the liquid dispensing device to the at least one container. Such a liquid dispensing system is known, e.g. from U.S. Pat. No. 7,178,702 or from WO 2008/082289 A1.

Nowadays consumer goods are increasingly bought on the internet. This applies not just to clothing, shoes and electronics, but also to day-to-day shopping. This development has implications for the design of products, which must lend themselves to being shipped in small quantities or even individually, possibly in combination with other types of goods. Moreover, since physical inspection of goods before purchase is not possible, and since no retailer is involved as link between the consumer and the manufacturer involved, it is increasingly important to ensure that products cannot be tampered with, so that the consumer gets the exact product that he has ordered.

Another challenge in product design nowadays is sustainability.

The invention has for its object to provide a liquid dispensing system that meets the demands of both e-commerce and sustainability. In accordance with a first aspect of the invention, this is achieved by providing the liquid dispensing system with means for preventing refilling of the at least one container. Such refill prevention means are effective in ensuring that the product in the container is the actual product which the consumer has ordered, usually a branded product. Moreover, the refill prevention means will also serve to avoid or at least reduce leaking of the liquid during transport of the container.

When the at least one container has a neck defining a fill opening for the liquid, the refill prevention means preferably includes a restriction element which almost completely closes off the fill opening. By reducing the size of the opening in the container, it becomes almost impossible to introduce liquid into the container through the neck, which makes refilling unattractive from a commercial point of view.

Obviously, in order to allow the liquid to be dispensed, an opening must remain, but the opening included in the restriction element has a cross-sectional area that is substantial smaller than that of the fill opening.

In an embodiment of the invention, the system includes a valve closing off the opening in the restriction element. Such a valve, which may be a one-way valve, ensures that liquid cannot be introduced into the container, but at the same time allows unrestricted flow of liquid from the container to the dispensing device.

In order to further prevent refilling, the opening may form part of a narrow conduit extending into the container. In this way liquid flow into the container through the restriction element is even further impeded.

In order to prevent the restriction element from being removed, it is preferably fixed in the neck of the at least one container. This allows the containers to be sold separately, and to be connected to a liquid dispensing device which the consumer already owns, e.g. from a previous purchase.

In one embodiment the fill opening of the at least one container is closed by a cap and, when in a transport or storage condition, the liquid dispensing device is connected to an outside of the container or its cap. By releasably connecting the device to the outside of the container or to its cap during transport and operation, instead of transporting a readily assembled system, all containers may be filled, closed and handled in the same way, regardless of whether or not they are sold in combination with a liquid dispensing device.

The restriction element may be releasably connected to the liquid dispensing device. In that way it can be automatically inserted into and fixed in the neck of the container when the liquid dispensing system is assembled.

The system of the invention may include a plurality of containers which are each arranged to be successively connected to the liquid dispensing device. In this way, a single device can be used repeatedly, and does not have to be discarded when the first container is emptied. This results in a more efficient use of resources and a reduction of waste.

In one embodiment the liquid dispensing device has a liquid inlet opening having a free diameter that is smaller than that of a standard dip tube. This prevents the device from being provided with a dip tube and then being used in conjunction with a different container lacking the refill prevention means, e.g. a container from a competing brand.

To prevent the parts of the system from being used by competitors, the liquid dispensing device and the at least one container or the refill prevention means may further include cooperating keying features.

In one embodiment the keying features may include a pin protruding from the lower part of the liquid dispensing device and a recess formed in an upper part of the container or the refill prevention means. By varying the position of the pin and the recess, dispensing systems may be provided for different brands.

When the recess is formed in the restriction element, the design of the container is not affected by the keying features.

In accordance with another aspect of the invention, the liquid dispensing device and/or the at least one container is at least partially made of recycled plastic material, in particular recycled consumer plastic waste. By using recycled plastic material for large parts of the dispensing device and the container, the use of resources is further reduced.

In one embodiment the liquid dispensing device includes a spring biased actuator which is made of virgin plastic material. This virgin material may have superior characteristics in comparison to recycled material, which may be of importance for some highly stressed parts of the dispensing system.

In a further embodiment of the liquid dispensing system, the at least one container includes an inner container for storing the liquid to be dispensed and an outer container, wherein a hole is formed in the outer container to allow air to penetrate a space defined between the inner and outer containers. Such a container, which is also known as “bag-in-bottle” and which is marketed by the applicant under the trademark Flair® prevents the liquid from contact with the environment, which is a further guarantee for the quality of the liquid. Moreover, this structure further prevents refilling, since the outer container will be almost completely filled with air when all liquid has been dispensed from the inner container. This air further impedes entry of liquid into the inner container.

In one embodiment of the system, the inner container may be made of recycled plastic material. The inner container has less effect on the aesthetics of the system than the outer container, which may be made of virgin plastic material.

The invention also relates to a method of dispensing a liquid, comprising the steps of filling at least one container with the liquid to be dispensed, providing a liquid dispensing device, connecting the liquid dispensing device to the at least one container, and actuating the liquid dispensing device. Such a method is also disclosed, at least implicitly, in the two cited prior art documents.

In accordance with an aspect of the present invention, after filling the container is provided with means for preventing refilling thereof. The advantages of such refill prevention means have been discussed in detail above.

The refill prevention means may be arranged on the at least one container before the liquid dispensing device is connected to the container, since the container is then still freely accessible.

In one embodiment, the container may be closed off by a cap after filling thereof. The container may then be sold separately to a consumer who already owns a matching dispensing device.

In another embodiment, the liquid dispensing device may be releasably connected to the outside of the container or the cap for transport or storage. In this way the entire system is sold as a whole, but is only assembled after it is received by the end user.

In another embodiment the refill prevention means is releasably connected to the liquid dispensing device and is arranged on the at least one container when the liquid dispensing device is connected thereto. In this way only a single operation needs to be performed on the container after filling, i.e. placing the dispensing device including the refill prevention means on the container.

In accordance with another aspect of the invention, the liquid dispensing device and/or the at least one container is at least partially made of recycled plastic material, in particular recycled consumer plastic waste. The advantages of using recycled material have been discussed above.

The invention will now be illustrated by means of a number of exemplary embodiments thereof, wherein reference is made to the accompanying drawings, in which corresponding elements are identified by reference numerals incremented by ‘100’, and in which:

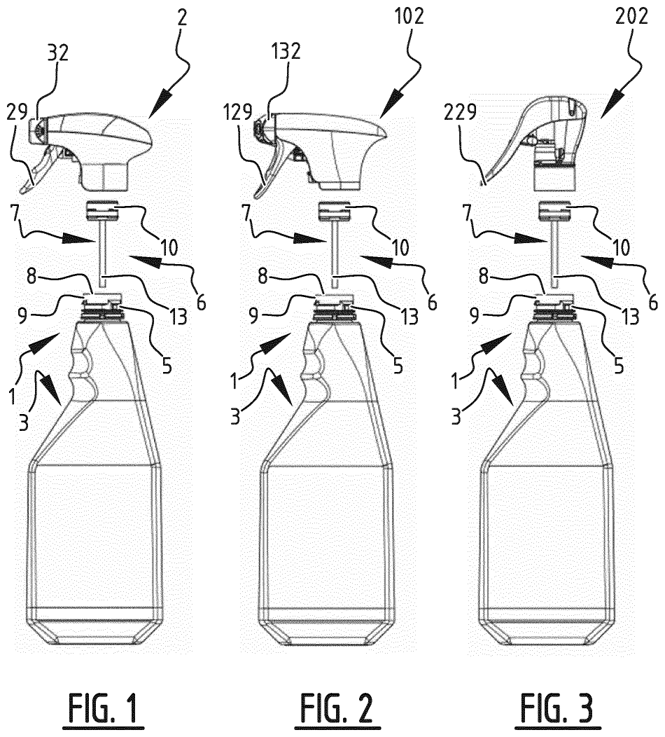

FIG. 1 is an exploded side view of a first embodiment of a liquid dispensing system in accordance with the invention,

FIGS. 2-6 are views corresponding with FIG. 1 of alternative embodiments of the liquid dispensing system,

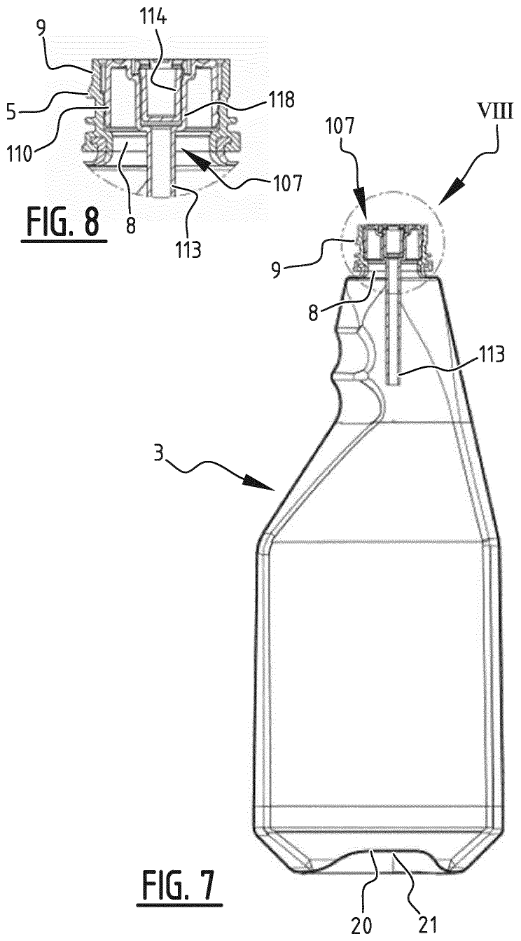

FIG. 7 shows a longitudinal sectional view of a container including refill prevention means in accordance with an embodiment of the invention,

FIG. 8 is an enlarged view of detail VIII of the refill prevention means of FIG. 7,

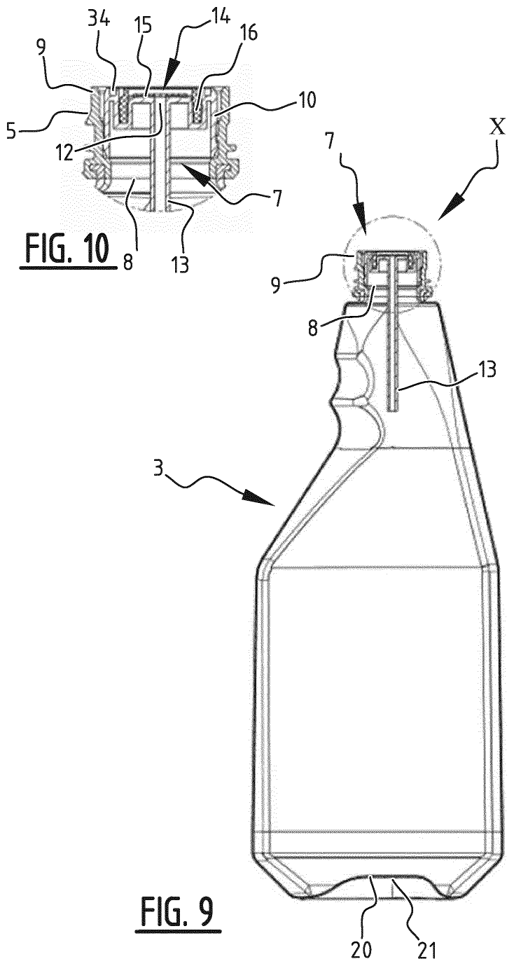

FIGS. 9-12 are views corresponding with FIGS. 7 and 8, respectively, of further embodiments of the invention,

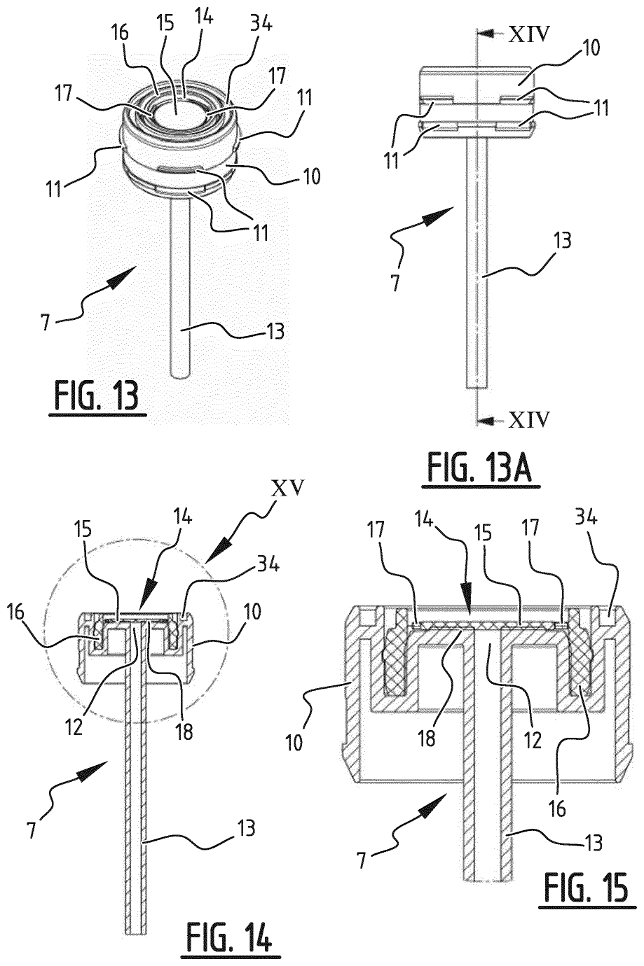

FIG. 13 is a perspective view of the refill prevention means as shown in FIGS. 9 and 10,

FIG. 13A is a side view of the refill prevention means of FIG. 13,

FIG. 14 is a longitudinal sectional view along the lines XIV-XIV in FIG. 13,

FIG. 15 is an enlarged view of the detail identified as XV in FIG. 14,

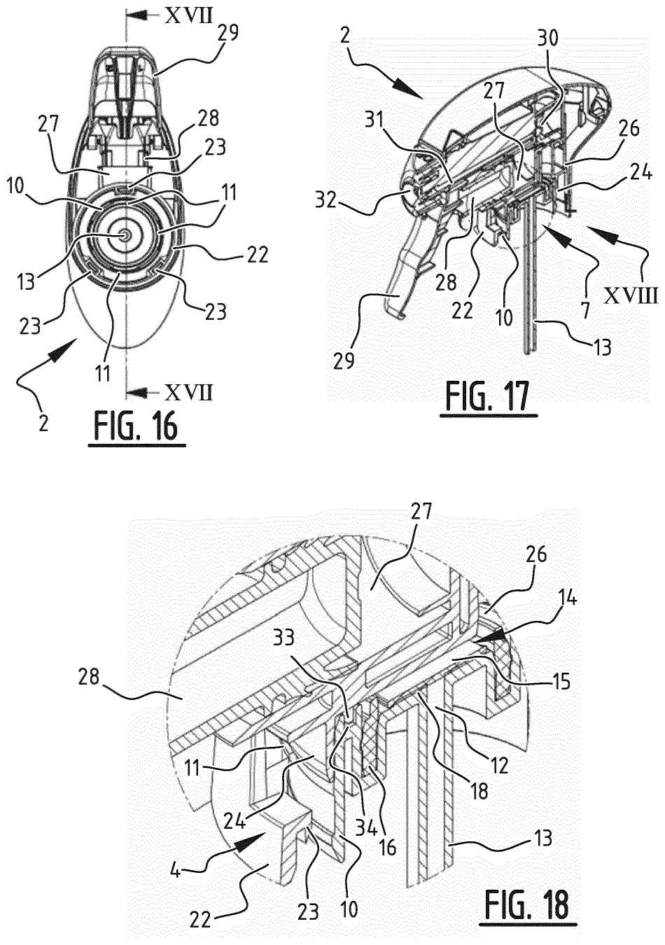

FIG. 16 is a bottom view of the dispensing device as shown in FIG. 1, in which the refill prevention means is connected to the dispensing device,

FIG. 17 is a perspective cross-sectional view of the dispensing device along the line XVII-XVII in FIG. 16,

FIG. 18 is an enlarged scale view of the detail identified by arrow XVIII in FIG. 17,

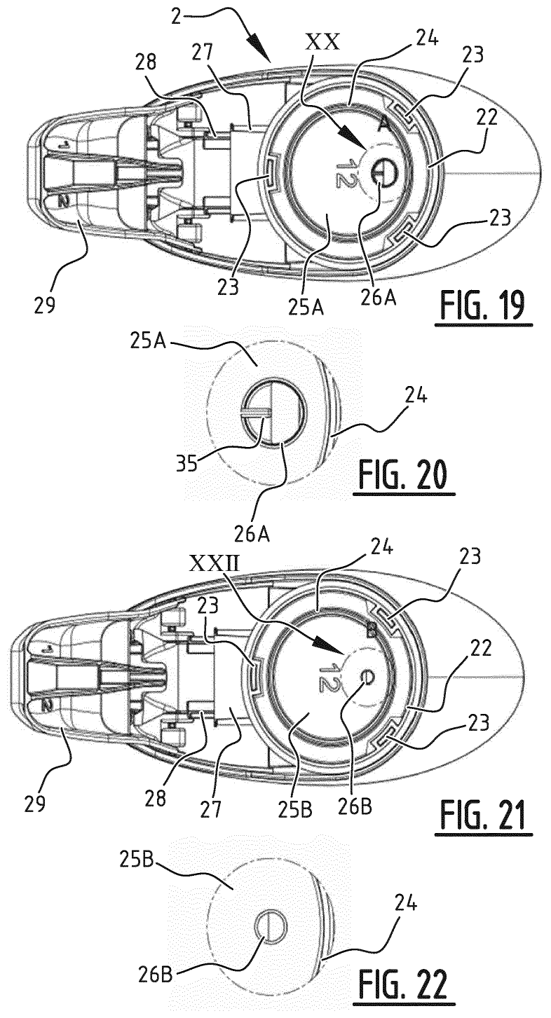

FIG. 19 is a bottom view of the dispensing device of FIGS. 16-18 without the refill prevention means,

FIG. 20 is an enlarged scale view of the detail identified as XX in FIG. 19, showing how the free cross-sectional area of the inlet opening is reduced to prevent insertion of a standard dip tube,

FIGS. 21 and 22 correspond with FIGS. 19 and 20, respectively, and show a further embodiment,

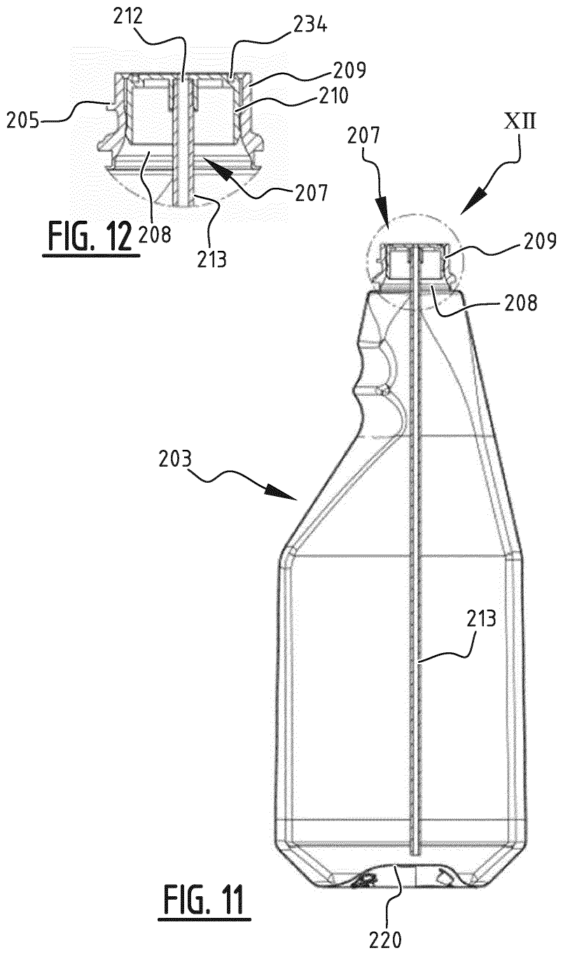

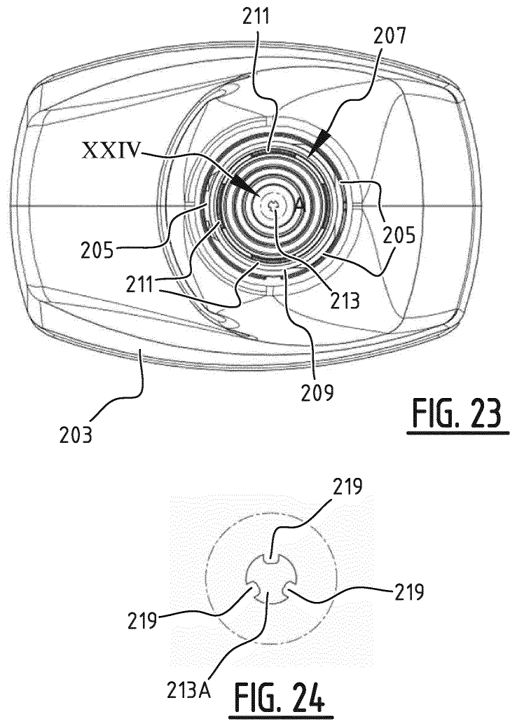

FIG. 23 is a top view of the container of FIG. 11 including the refill prevention means and illustrating a possible configuration of the opening therein,

FIG. 24 is an enlarged scale view of the detail XXIV in FIG. 23,

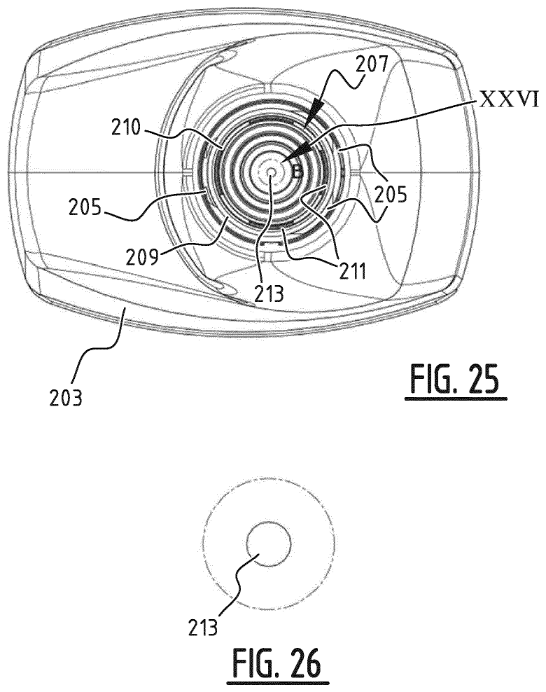

FIGS. 25 and 26 correspond with FIGS. 23 and 24 and show yet another embodiment,

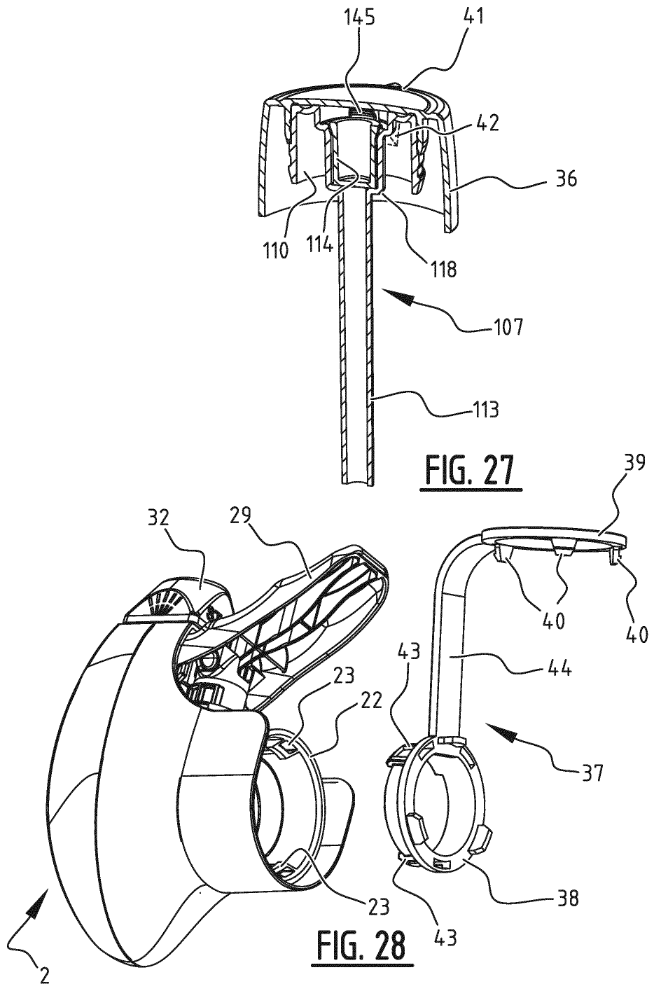

FIG. 27 shows a cap including a restriction element of the type shown in FIGS. 7 and 8,

FIG. 28 shows a dispensing device and a connector,

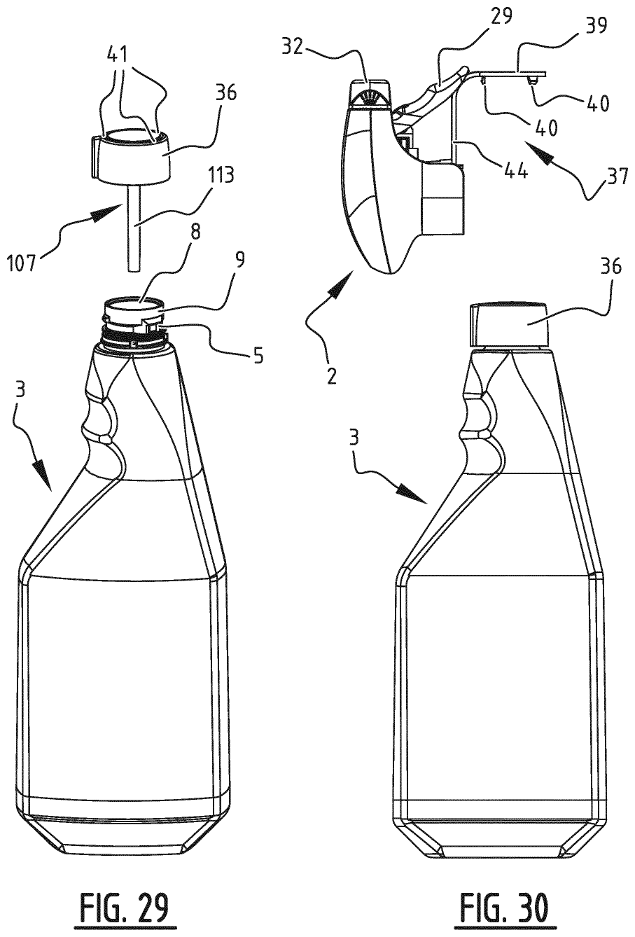

FIG. 29 shows the cap of FIG. 27 being placed on the container, and

FIG. 30 shows the dispensing device of FIG. 28 being connected to the container of FIG. 29.

A liquid dispensing system 1 comprises a liquid dispensing device 2 and a container 3 for storing the liquid to be dispensed (FIG. 1). The dispensing device 2 has first connecting means 4, e.g. inwardly extending lugs 23 (FIGS. 17, 18) and the container 3 has second connecting means 5, e.g. protruding ribs, which cooperate with the first connecting means 4 to form a releasable connection between the dispensing device 2 and the container 3. An example of such first and second connecting means is disclosed in the above-mentioned document WO 2008/082289 A1. In accordance with the invention, the liquid dispensing system 1 includes means 6 for preventing refilling of the container 3.

In the illustrated embodiment, these refill prevention means comprise a restriction element 7 which is inserted in a fill opening 8 that is defined by a neck 9 of the container 3. The restriction element 7 almost completely closes off the fill opening 8. It includes a plug 10 having an outer diameter which substantially corresponds with a diameter of the fill opening which is bordered by the neck 9. Spaced protrusions 11 on the outer surface of the plug 10 (FIGS. 13, 13A) serve to fix the restriction element 7 in the neck 9.

An opening 12 is formed in a central part of the restriction element 7 (FIGS. 14, 15). This opening 12 has a cross-sectional area that is substantially smaller than the cross-sectional area of the fill opening 8. The opening 12 forms part of a narrow conduit 13 which extends downward from the plug 10 into the interior of the container 3. In the illustrated embodiment the opening 12 is closed off by a valve 14. This valve includes a disc 15 which is connected to a ring 16 by means of a number of curved connecting arms 17 which extend along part of the circumference of the disc 15 and which have one end attached to the disc 15 and an opposite end attached to the ring 16. When suction is applied to the disc 15 due to actuation of the dispensing device 2, the disc 15 is lifted from a valve seat 18 surrounding the opening 12 and the arms 17 stretch and pivot upwards. In this way liquid may be drawn from the container 3 through the conduit 13 to the opening 12 and then to the device 2.

However, as long as the dispensing device is not actuated, the disc 15 is biased towards the valve seat 18 by the connecting arms 17 and the valve 14 remains closed. In this way no liquid can leak from the container 3. Moreover, any attempt to refill the container 3 through the opening 12 will fail, since the disc 15 will be pressed onto the valve seat and will close off the entry to the container 3.

In another embodiment of the restriction element 107, the valve 114 is substantially cup shaped, and is received in a widened part 118 of the conduit 113, where it is held by a number of lugs 45 (FIGS. 7, 8, 27). In this case the valve 114 is not movable, but rather deformable so as to create a connection between the conduit 113 and the outside. In this case, when suction is applied by actuation of the dispensing device 2, the cup shaped valve 114 contracts somewhat, thus creating a narrow slit-shaped opening 112 between the sidewall of the cup shaped valve 114 and the sidewall of the widened part 118. Here again, as long as no suction is applied, the valve 114 will remain closed and will prevent any fluid from leaking out of the container 3 or from being introduced into the container 3 in an attempt to refill it.

In these two embodiments the conduit 13, 113 is relatively short, and extends only into the top part of the container 3.

In yet another embodiment of the restriction element 207 the conduit 213 is long enough to extend almost to a bottom part 220 of the container 203 (FIG. 11). In this embodiment the opening 212 is even smaller than in the other two embodiments, and is not closed by a valve. In this case, the length of the conduit 213 forms sufficient impediment against refilling. When an attempt is made to introduce liquid through the long and narrow conduit 213, the resistance will be so great that no useful amount of liquid can be refilled. In this embodiment the conduit 213 can have a non-circular cross-section, e.g. a cross-section with cut-outs 219 (FIGS. 23, 24), an elliptical cross-section or it could have a very small cross-section (FIGS. 25 and 26).

The embodiment of the restriction element 207 having a conduit 213 which extends almost to the bottom 220 of the container is especially useful when the container 203 is a standard container, i.e. a single-wall container.

In an advantageous embodiment, the container 3 is a so-called “bag-in-bottle” or Flair®-type container. Such a Flair®-type container includes a flexible inner container accommodating the liquid to be dispensed (the bag) and an outer container which is stronger and stiffer (the bottle) and which provides stability. Air can penetrate a space between the inner and outer containers, so as to fill the space that is left when liquid is dispensed. In this Flair®-type container the liquid is never in contact with the air, so that its quality is guaranteed. Moreover, the device can be used in any position, since the inner container is free of air. The Flair®-type container has an air hole 21, which in this case is arranged in the bottom portion 20 (FIGS. 7, 9). Since the restriction element 7 blocks any liquid flow when the dispensing device 2 is not actuated, there is no need for an air valve in the hole 21.

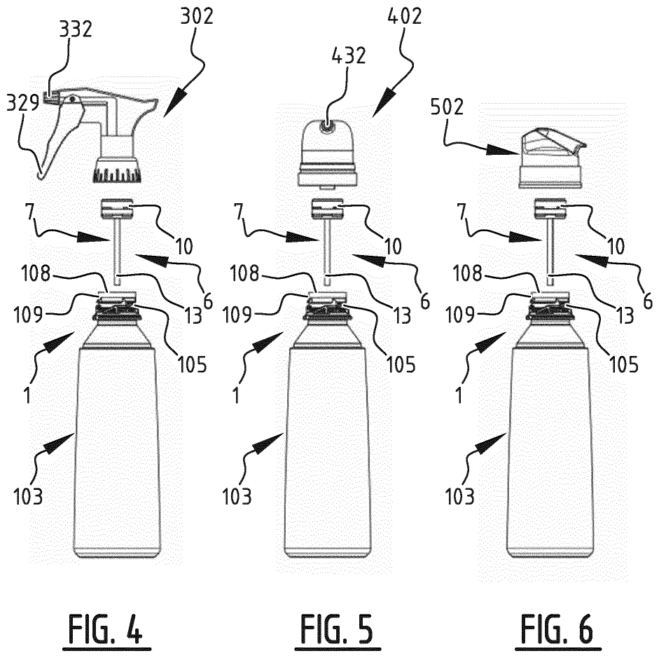

The dispensing device can be any type of dispensing device, e.g. a trigger sprayer of the type disclosed in the two above-mentioned prior arts, the applicant's OpUs precompression trigger sprayer 2 (FIG. 1) or OpAd precompression trigger sprayer 102 (FIG. 2), other types of trigger sprayers 202, 302 (FIGS. 3, 4), a hand pump 402 (FIG. 5) or some other type of dispensing device 502 as shown in FIG. 6.

In the illustrated embodiment the dispensing device 2 comprises a outer rim 22 including the first connecting means 4, which in this embodiment comprises three circumferentially spaced protrusions 23 (FIG. 16). The device 2 further includes an inner rim 24 which is intended for sealingly engaging the neck 9 of the container 3 (FIG. 17, 18). The device 2 has a flat bottom 25, which allows the device 2 to be rotated over the neck 9 when connecting or disconnecting the device 2 to and from the container 3. An inlet 26 in the bottom allows liquid to be drawn into the device 2, into a pump chamber 27. A piston 28 reciprocates in the pump chamber 27 when a user actuates a trigger 29, the piston and trigger being returned by a spring (not shown). Moving the piston will pressurize the liquid, which will then flow past a precompression valve 30 into a conduit 31 that leads to a nozzle 32.

In order to prevent the dispensing device 2 from being used in combination with a non-matching container, i.e. a container filled with a different brand of liquid, the dispensing device 2 and the container 3 or restriction element 7 include cooperating keying features. In the illustrated embodiment the dispensing device 2 includes a first keying feature in the shape of a pin 33 protruding from the bottom 25. The second keying feature is a recess 34 in the upper surface of the restriction element 7. In this case the recess 34 is annular, so that the dispensing device 2 may be connected to the container 3 in any rotational position. For another brand of liquid a different radial position of the pin and the recess may be selected. In this way it is ensured that the dispensing device 2 can only be used in combination with a matching container 3.

Here the first and third embodiments of the restriction element 7, 207 have their respective recesses 34, 234 at the same radius from their center, which implies that they can be used with same dispensing device 2. The second embodiment of the restriction element 107, on the other hand, does not have a recess at this position. Therefore, this embodiment cannot be used with this dispensing device 2, since the protruding pin 33 would prevent the restriction element 107 from being properly inserted into the inner rim 24 all the way up to the bottom 25 of the dispensing device 2.

Moreover, in order to prevent a user from inserting a dip tube into the dispensing device 2 so that it may be used with a standard container filled with liquid from a different manufacturer than the one which provided the dispensing device 2, the inlet 26 may have a free diameter which is smaller than that of a conventional dip tube. In the embodiment of the dispensing device 2 shown in FIGS. 19, 20 this is achieved by arranging an obstacle 35 in the standard size inlet 26A. In the embodiment of FIGS. 21, 22 on the other hand, the design of the dispensing device 2 is adapted to include a smaller size inlet 26B.

As stated above, the restriction element 7 may be releasably connected to the dispensing device 2 before being placed in the container 3. This is shown in FIGS. 16-18. As soon as the dispensing device 2 is mounted on the neck 9 of the container 3, the restriction element 7 is forced into the neck 9 and its protrusions 11 on the plug 10 will engage the inside of the neck 9, thus fixing the restriction element 7 in the container 3 and blocking any flow of liquid through the fill opening 8. When the dispensing device 2 is subsequently disconnected from the container 3, e.g. after all liquid has been dispensed, the restriction element 7 will remain locked in the container 3 and the dispensing device 2 may be used in combination with a new container 3 having its own restriction element 7.

Such a container 3 with restriction element 7 may be formed by releasably connecting a restriction element, in this example the second embodiment of the restriction element 107 to a cap 36 (FIG. 27). The cap 36 may have connection means that are similar to the first connection means 4 of the dispensing device 2, e.g. inwardly extending lugs 42, so that it can be sealingly connected to the neck 9 of the container 3. Here again, when the cap 36 is mounted on the neck 9 of the container 3 after this has been filled with liquid (FIG. 29), the restriction element 107 will be fixed inside the neck 9. When the cap 36 is subsequently removed to connect the container 3 to the dispensing device 2, the restriction element 107 will remain locked inside the container neck 9, blocking the fill opening 8.

Instead of assembling the dispensing device 2 and the container 3 at a manufacturing plant, the dispensing device may be loosely connected to the container 3 for transport or storage, and may be assembled by the end user. In this way all containers 3 can be filled, closed and handled in the same way, regardless of whether they are to be delivered in combination with a dispensing device 2, or without such a device, as replacement for the first container 3. To this end a separate connector 37 can be provided (FIG. 28). This connector 37 includes a first annular part 38 having protruding ribs 43 which mimic the second connection means 5 on the container neck 9 and can be connected to the rim 22 and lugs 23 of the dispensing device 2. The connector 37 further has a substantially L-shaped strip 44 and a second annular part 39 at the end of the strip 44 having three protrusions 40 that can be inserted into three openings 41 in the cap 36. These three openings 41 are formed as a result of forming the lugs 42 of the connection means in the cap 36. The connector 37 may not only serve for temporarily connecting the device 2 to the container 3, but may also constitute a trigger lock when the first annular part 38 is fixed to the rim 22 and the L-shaped strip 44 engages the back of the trigger 29 (FIG. 30).

The invention allows a single dispensing device to be used more than once in combination with a number of containers. In this way unnecessary waste as a result of discarding a fully functioning dispensing device is avoided. In order to prevent abuse of the system by combining the device with a container that has been refilled with a liquid of unknown origin, the system includes a refill prevention means. In this way the quality of the liquid that is dispensed can be guaranteed. Moreover, the system includes various provisions to prevent abuse by combining the device with other containers than the ones for which it is intended. The containers and the dispensing device are for a large part made of recycled plastic materials, in particular recycled consumer plastic waste, which further reduces the use of resources and the carbon footprint. In this way a closed loop system is formed, in which empty containers, may be easily recycled, while the dispensing device remains in use for a prolonged period of time.

The invention is not limited to the illustrated embodiments.

1-28. (canceled)

29. A liquid dispensing system comprising a liquid dispensing device and at least one container for storing the liquid to be dispensed, wherein the liquid dispensing device includes a first connector and the at least one container contains a second connector, said first and second connectors being arranged to cooperate to releasably connect the liquid dispensing device to the at least one container, further comprising a refill preventer for preventing refilling of the at least one container.

30. The liquid dispensing system according to claim 29, wherein the at least one container has a neck defining an fill opening for the liquid and the refill preventer includes a restrictor which almost completely closes off the fill opening.

31. The liquid dispensing system according to claim 30, wherein the restrictor includes an opening having a cross sectional area that is substantially smaller than that of the fill opening, and optionally wherein a valve is arranged to close off the opening in the restrictor.

32. The liquid dispensing system according to claim 31, wherein the opening forms part of a narrow conduit extending into the container.

33. The liquid dispensing system according to claim 30, wherein one of:
the restrictor is fixed in the neck of the at least one container, and optionally wherein the fill opening of the at least one container is closed by a cap and, when in a transport or storage condition, the liquid dispensing device is connected to an outside of the container or its cap; or
the restrictor is releasably connected to the liquid dispensing device.

34. The liquid dispensing system according to claim 29, wherein the liquid dispensing system comprises a plurality of containers which are each arranged to be successively connected to the liquid dispensing device.

35. The liquid dispensing system according to claim 29, wherein the liquid dispensing device has a liquid inlet opening having a free diameter that is smaller than that of a standard dip tube.

36. The liquid dispensing system according to claim 29, wherein the liquid dispensing device includes a first keying feature and the at least one container or the refill preventer includes a second keying feature cooperating with the first keying feature; and optionally wherein the first and second keying features include a pin protruding from a lower part of the liquid dispensing device and a recess formed in an upper part of the container or an upper part of the refill preventer, or vice versa; and optionally wherein the recess is formed in the restrictor.

37. The liquid dispensing system according to claim 29, wherein the liquid dispensing device and/or the at least one container is at least partially made of recycled plastic material, in particular recycled consumer plastic waste; and optionally wherein the liquid dispensing device includes a spring biased actuator which is made of virgin plastic material.

38. The liquid dispensing system according to claim 29, wherein the at least one container includes an inner container for storing the liquid to be dispensed and an outer container, wherein a hole is formed in the outer container to allow air to penetrate a space defined between the inner and outer containers.

39. The liquid dispensing system according to claim 38, wherein the inner container is made of recycled plastic material.

40. A method of dispensing a liquid, comprising the steps of:
filling at least one container with the liquid to be dispensed,
providing a liquid dispensing device,
connecting the liquid dispensing device to the at least one container, and
actuating the liquid dispensing device,
wherein after filling the container is provided with a refill preventer for preventing refilling thereof.

41. The method according to claim 40, wherein the refill preventer is arranged on the at least one container before the liquid dispensing device is connected to the container; and optionally wherein after filling the container is closed off by a cap.

42. The method according to claim 41, wherein the liquid dispensing device is releasably connected to the outside of the container or the cap for transport or storage.

43. The method according to claim 40, wherein at least one of:
the refill preventer is releasably connected to the liquid dispensing device and is arranged on the at least one container when the liquid dispensing device is connected thereto; or
after the liquid has been dispensed from the container, the liquid dispensing device is disconnected from the container and is connected to a new container filled with liquid; or
the liquid dispensing device and/or the at least one container is at least partially made of recycled plastic material, in particular recycled consumer plastic waste.

44. The liquid dispensing device for use in the liquid dispensing system according to claim 29.

45. The container for use in the liquid dispensing system according to claim 29, optionally wherein the container further comprises a neck defining a fill opening, a restrictor fixed in the neck and a cap closing off the fill opening.

46. The restrictor for use in the liquid dispensing system according to claim 30.

47. A liquid dispensing system comprising a liquid dispensing device and at least one container for storing the liquid to be dispensed, wherein the liquid dispensing device includes a first connector and the at least one container contains a second connector, said first and second connectors being arranged to cooperate to releasably connect the liquid dispensing device to the at least one container, wherein the liquid dispensing device and/or the at least one container is at least partially made of recycled plastic material, in particular recycled consumer plastic waste.

48. A method of dispensing a liquid, comprising the steps of:
filling at least one container with the liquid to be dispensed,
providing a liquid dispensing device,
connecting the liquid dispensing device to the at least one container, and
actuating the liquid dispensing device,
wherein the liquid dispensing device and/or the at least one container is at least partially made of recycled plastic material, in particular recycled consumer plastic waste.
